(19) United States
(12) Patent Application Publication
(10) Pub. No.: US 2003/0009924 A1
(43) Pub. Date: Jan. 16, 2003

(54) Outdoor numeric/allphabetic lighting

(76) Inventor: Zahra Nassrin Sajadian, Anaheim Hills, CA (US)

Correspondence Address: Zahra Nassrin Sajadian, 5409 Estate Ridge Road, Anaheim Hills, CA, 92807, US

(21) Appl. No.: 10/173,171

(22) Filed: Jun. 17, 2002

Related U.S. Application Data
(63) Continuation-in-part of application No. 29/132,155, filed on Nov. 3, 2000, now abandoned.

(51) Int. Cl. G09F 13/04; F21V 15/00

(52) U.S. Cl. 40/564; 362/362; 40/607

(57) ABSTRACT

The unique aspect of this invention is the utilization of numbers and letters as lighting to be placed outdoors so as to distinguish the property it is placed in front of. Each individual lighting unit would have a hollow plastic number or letter that would illuminate from an internal source so as to be visible at night and these units could be arranged together and placed outdoors to display street address numbers or whatever the individual cared to create to distinguish their property.

### CROSS-REFERENCE TO RELATED APPLICATIONS

This application is a continuation in part of application number 29,132,155 on Oct. 30, 2000 in titled low voltage outdoor numeric/alphabetic lighting. The patent process started with the Disclosure Document Number 459585 on Jul. 20, 1999, which was then followed by the application number on Oct. 30, 2000. This invention does not explicitly cross-reference any other previously patented idea or mechanism.

### STATEMENT REGARDING FEDERALLY SPONSORED RESEARCH OR DEVELOPMENT

This idea was not the result of any federally sponsored research or development, but is the sole and independent idea of the inventor, Zahra Nassrin Sajadian, working individually and with no outside assistance, private or public.

### BACKGROUND OF THE INVENTION

The invention in question here is a design of lighting that would allow address or street numbers to be illuminated and placed above the curb thereby allowing them to be easily visible from the street and facilitating the finding of any home, business or other location by the address number. This invention is essentially a hollow high-density plastic tube of varying colors in the shape of numbers from 0 to 9 in various fonts, designs, sizes, and styles. This invention also includes all the letters in the English alphabet, from A to Z, also of various fonts, designs, sizes, and styles. These numbers and alphabets can also be produced in the format of any other languages. The tube would have a light source inside that would illuminate the entire number or letter portion of the device. There would be one number or letter per lighting unit. These lights would have pointed and elongated bottoms so that they could then be placed in lawns, in front lawns or by street curbs. These lights could be arranged on front lawns to display words or street address number so that the particular location would be easy to find. The numbers would be placed together and would be illuminated at night such that the numbers would be visible and people could place their address numbers in front of their home to distinguish their residence, business or other location by the mailing address street numbers. These lighting devices would be powered by internal commercial batteries or externally by common electric utility outlets, depending on the model. The internal functioning of this device would be identical to other lamps or lights currently available on the market and would mirror their design. However, the illuminated number and letter aspect of this is unique and not commercially available and is the portion of the device that is the subject of this patent.

### BRIEF SUMMARY OF THE PATENT

This patent is designed to facilitate the finding of any residence, business, or other address by its street number and signs. Currently, street numbers are painted on curbs in front of buildings or painted or lettered on the side of the buildings. These are extremely difficult to see at night and therefore, it is difficult to find those locations when one is looking for the street numbers. By illuminating the numbers, it not only makes the particular address much easier to find at night, it also helps to distinguish the particular location from its surroundings, so as to attract business in a commercial venue, or to add a unique quality to a residence. This idea also encompasses letters so that a company can place its name it lights in front of its location for a much more affordable option that buying a custom made neon lighting system. Also residences can spell out their name or other phrases, for example “Graduation Party”.

Theoretically, these lights would be available at retail stores in a variety of colors and styles. Consumers could then just by lights individually, one number or letter per light, and make any phrase or number combination that they wished.

### BRIEF DESCRIPTION OF THE DRAWING

The drawing illustrates the different numbering possibilities of the invention. The drawing only illustrates a few numbers but space limitations prohibit drawing every number and letter. The drawing illustrates that there would be one number or letter per unit. That each unit could have an elongated spike or point at the bottom to facilitate pushing the unit into grass or dirt or other form of earth. The drawing attempt to illustrate the number in three dimensions to show that they are in fact hollow, bulbous, formations of those numbers and not merely two-dimensional or flat. The numbers would be sufficiently bulbous to allow for the lighting device to fit safely inside. The lighting device would be a low-voltage device so as not to give off too much light or heat. The lighting must only be enough to illuminate the numbering or lettering immediately around it. The unique aspect of this idea is the design: hollow colored numbers or letters illuminated from inside and design to be placed outdoors to facilitate the finding of street address numbers or for the other reasons listed herein.

### DETAILED DESCRIPTION OF INVENTION

The invention would be created as follows: High density plastic would be formed in the shape of numbers and letters in different fonts, colors and styles. These plastic forms would be formed so as to be hollow, enough to allow the lighting unit, bulb, to fit safely and securely inside. Then, a lighting device, similar to any common lamp or flashlight, would be designed with the following specifications: The power output and lighting intensity would be kept small; the light can be low-voltage for safety and practical reasons. The light source does not have to be very intense at all to illuminate the internal husk of the plastic numbers or letters. These lighting units would be equipped with either internal battery operated power sources or external plugs to plug into electric outlets. Additionally, each of these lighting units could have an elongated spike or point at the bottom to facilitate pushing the unit into grass or dirt or other form of earth. Moreover, these fixtures can also be attached along side a pole (for example: street signs and street names). The numbers and alphabetic letterings can also be placed in boxes or flat panels that can brightly show the number or lettering. For example, numbers and/or letters can be displayed within and/or on a thin plastic, steel, alumni or any other material to illuminate the light of these letters and numbers. Furthermore, the material used to produce the light can be done in a number of ways and through the use of a number of products and chemicals. For example, a glow in the dark material can be used for the letterings and numbers.

### DETAILED DESCRIPTION OF THE DRAWING

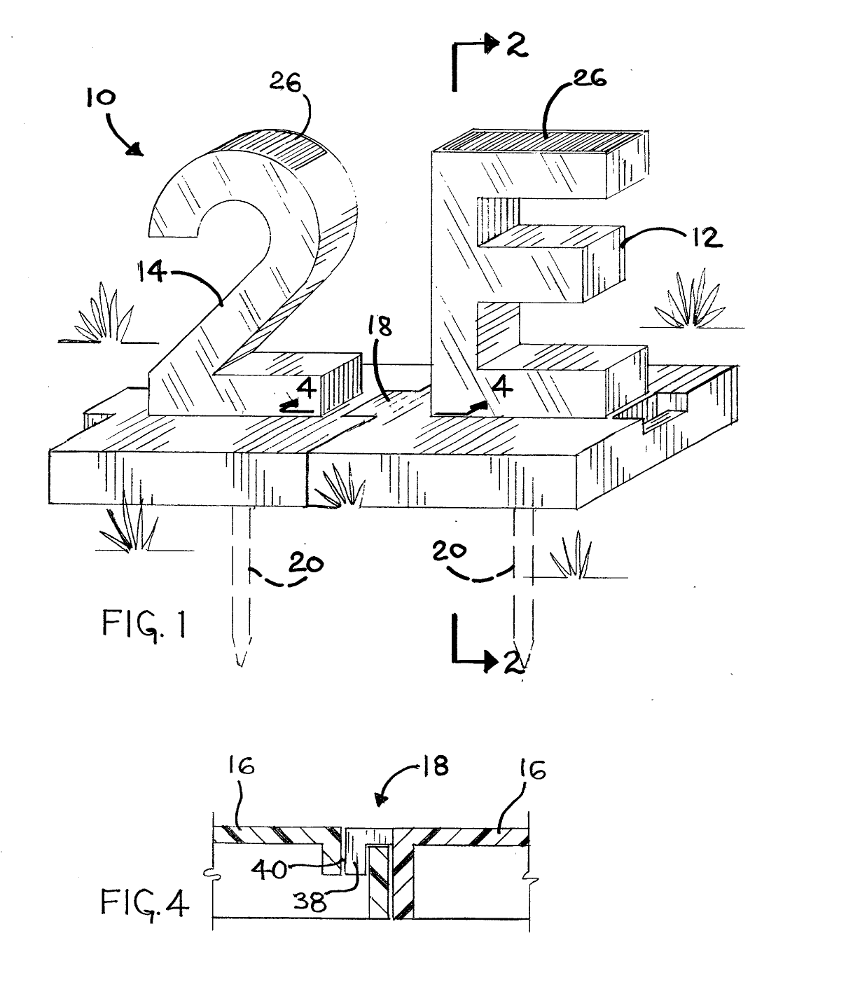

In FIG. 1 we see the basic elements of the invention (10). This consists of a set of either letters (12) or numbers (14), which mount individually to their own bases (16). These bases can then be interlocked at (18) using a tab-in-slot or similar method so that the bases will stay in snug alignment. In addition, spikes (20) may be driven downwards through selected bases in order to affix them to soft or uneven surfaces such as grass lawns, sand, or bare earth. When the bases are to be placed on a hard, flat surface, no spikes are required. Assembling these letters and/or numbers together will spell out a desired word or series of numbers.

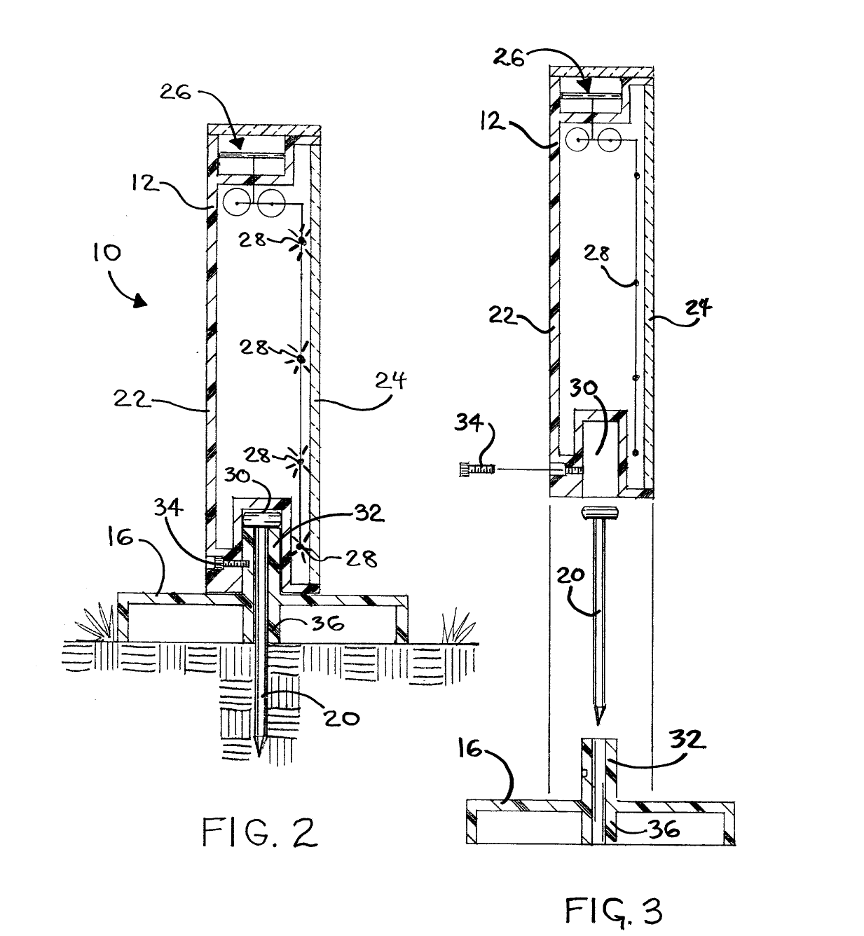

FIG. 2 is a cross sectional view of this system as taken through the letter “E”. Each letter or number consists of a hollow, opaque plastic body (22) with a transparent or translucent (26) which at night illuminates the letter or number via one or more LED or similar lighting elements (28). More mundane power sources can also be used to supply electric current for the lighting if so desired. Each number or letter unit also has a cylindrical shaft (30) open at the bottom to receive a mounting post (32), which extends upward from each base (16). The posts (32) may also be of a square or polygonal cross section to resist the tendency to wiggle or spin. The letters (12) or numbers (14) may further be locked to their respective posts by a tiny bolt (34) or similar means to help resist the tendency for a prankster to rearrange or to steal them. Lastly, the base posts (32) are hollow to accept the insertion of a ground securing spike (20). To help guide the spikes straight down into the ground, and to reinforce the strength of the bases themselves, the shaft that holds the spike has an extension (36) down to the bottom level of the bases (16).

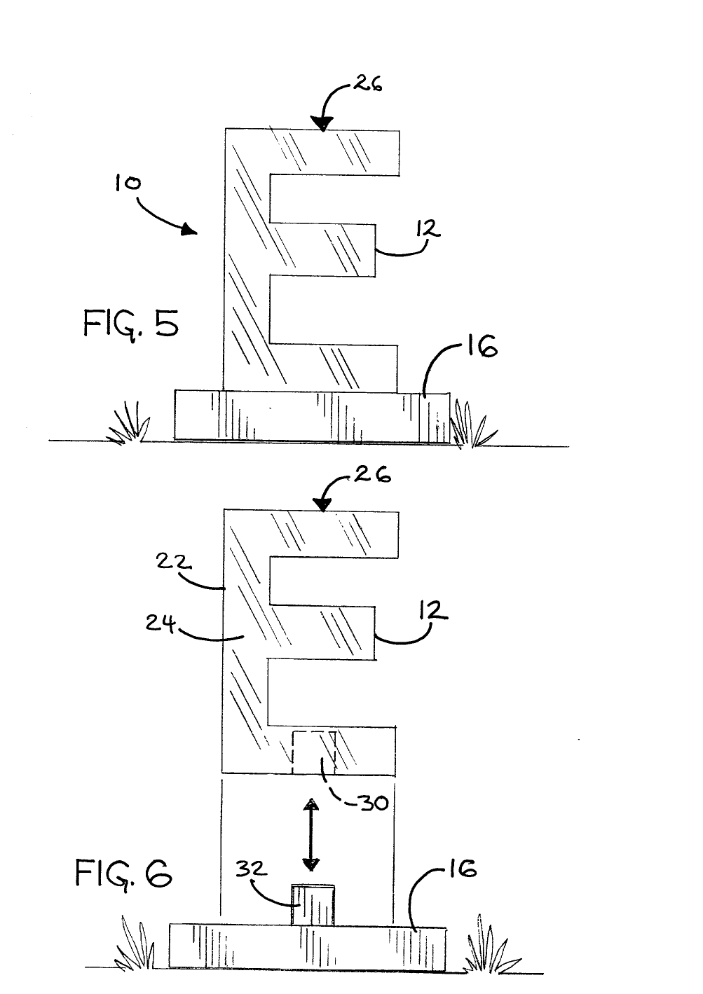

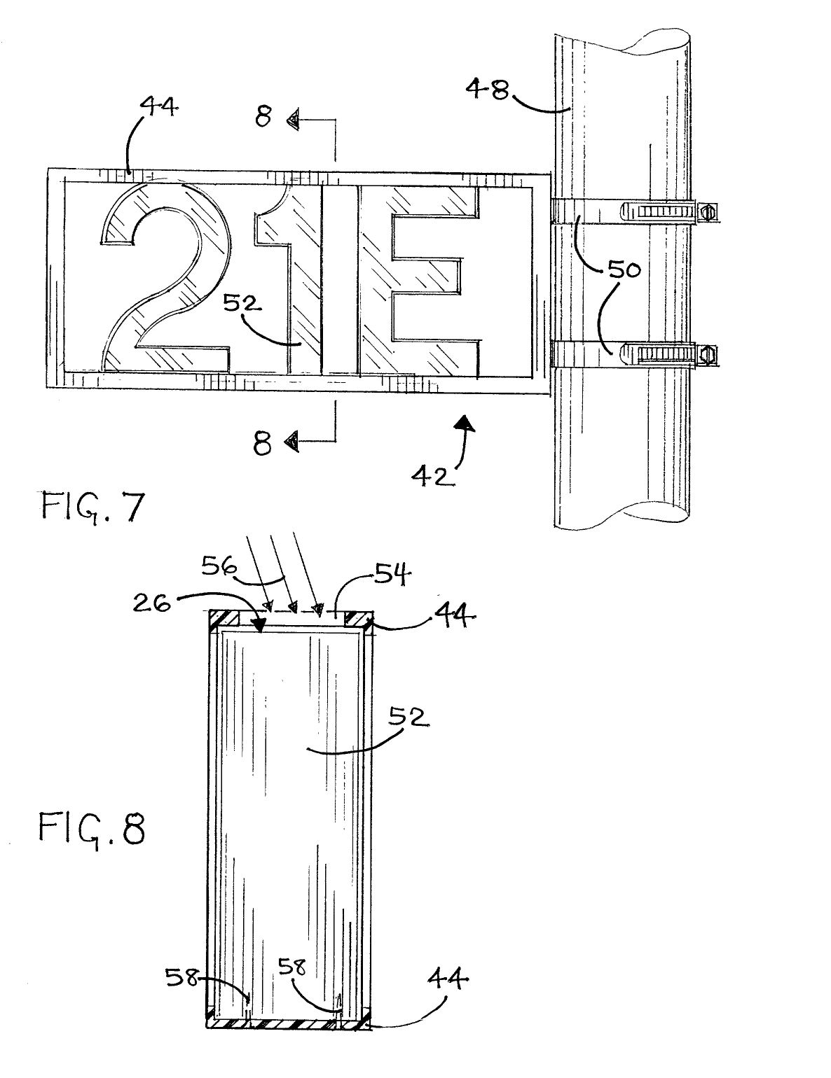

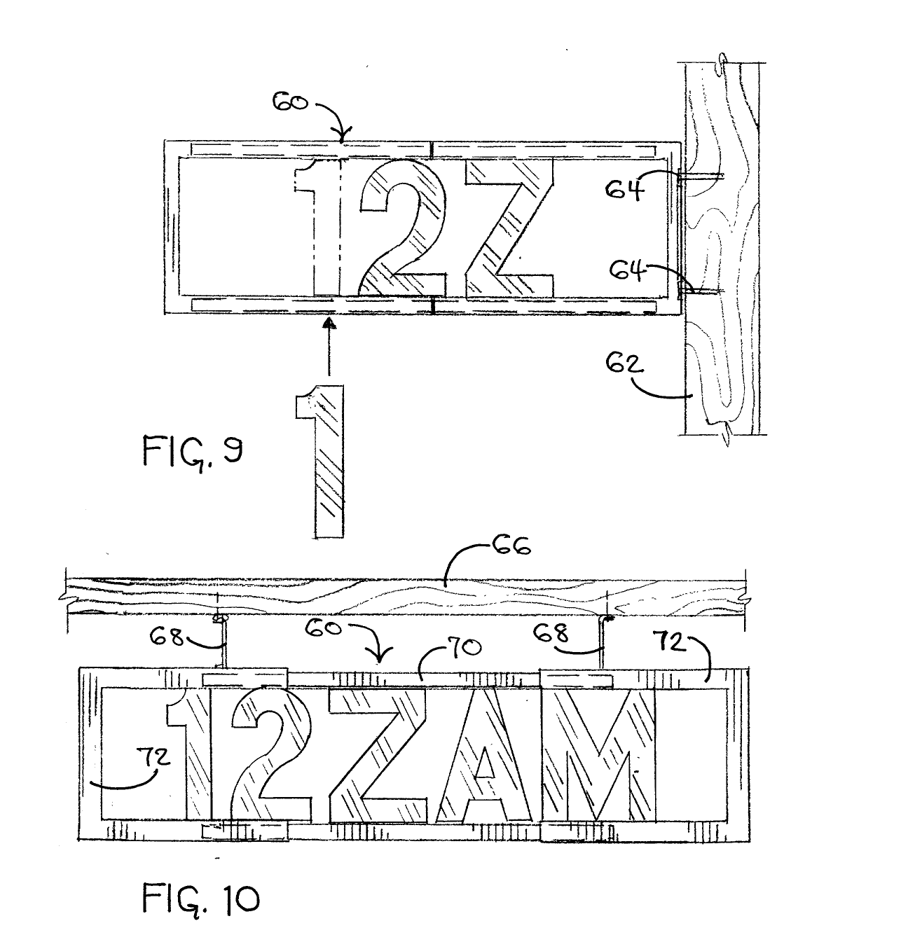

In FIG. 3 the letter unit is shown in an exploded view so we can better see the features described above.

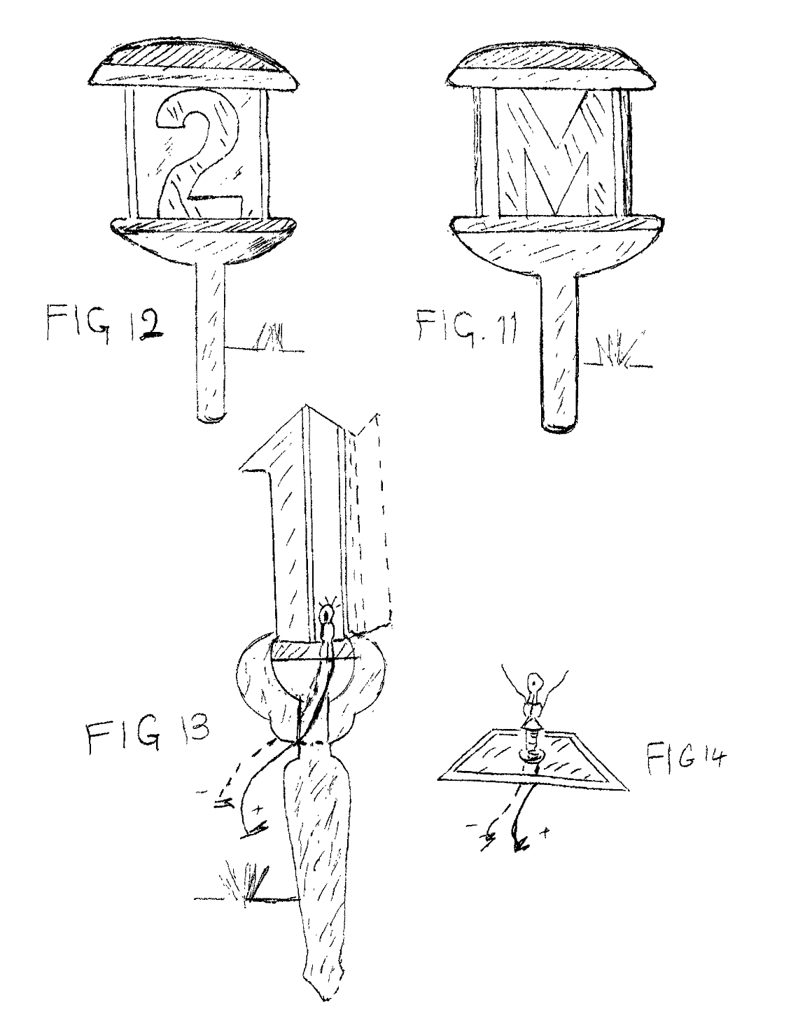

FIG. 4 shows a section through a typical joint between two bases (16). The section shows how a tongue or tab (38) on one end of each base (16) engages a slot (40) on the other end of each base (16).

In FIG. 5, the invention (10) is shown in its most basic form, that of a single unit (12) mounted on its base (16). At the top of this unit sits the solar cell receptor (26). FIG. 6 shows the same unit (10) pulled off its base (16) showing the post (32) and the cylinder (30) into which it locates.

In FIG. 7, we show a second embodiment for the invention (42). Here the individual number/letter units can be installed into or onto a rack-like frame (44) which could be mounted to a support by various means. In FIG. 7, the rack version (42) is shown strapped onto a round metal pole (48) by means of two hose-clamp style straps (50). FIG. 8 shows a cross section through this rack as it would look facing the number one unit (52). At the top of the rack is an opening (54) through which sunlight (56) passes in order to charge the solar cell (26) at the top of each alphanumeric unit. A simple means such as self-tapping screws (58) may be employed to fasten each letter/number unit to the rack (44).

While the rack in FIG. 7 is of a fixed length, another version would have an expandable rack (60) which is here shown mounted to a wooden post (62) using a uitable means such as lag screws (64). In this version of the invention, the expanding rack is shown in two modes. In the first mode, the rack is in its contracted position and is used to hold a minimum of characters. The number “1” is shown as a separate unit about to be inserted into the rack (60). In the second mode, the rack is shown extended to accept more characters. It is also shown in yet another potential mounting position where the rack is hung beneath a beam (66) using suitable hangers (68). The expandable rack consists of two or more elements which slide into each other as shown. In FIG. 10 we have a central section (70) on to which two end sections (72) are slid. The rack is then adjusted to accommodate the desired number of characters until a pleasing visual arrangement is achieved.

FIG. 11 and FIG. 12 have one difference between them. FIG. 11 displays the solar version light in letters, while FIG. 12 illustrates it in numbers. The figures show of a solar powered version of the light that is similar to the lights used for outdoor facilities, yet the lights in the figure consist of either letters or numbers. These lights can be positioned in the ground (in such places like a grass area, but not limited to any area or ground flooring) and typically (but not limited to) extend a foot above the ground for clear view.

FIG. 13 illustrates the light that can be placed with in fixture, yet the light does not have to be of a specific shape or size. The double parallel lines extending downward from that sphere would indicate the electrical wiring for the light source. These internal, non-visible, wires would then either lead to a battery or to a cord that would fit into any common electric outlet. Once again, the internal design of the unit is similar to any commercial lamp or light or flashlight. These electric lines do not have to be of a specific type nor do they have to be included to provide power. The source of power to generate the light can come from any source, such as (but not limited to) solar power. Additionally, these lighting units would have spikes or point at their bottoms, so they could be driven into lawns and earth. These spikes or point at their bottoms, so they could be driven into lawns and earth. These spikes would have to be sufficiently long enough to allow the number or letter portion of the invention to stand erectly and visibly above ground.

FIG. 14 displays the light that's placed within the fixture. Again the illustration shows the electric lining that provides the power to light the light bulb. Again, these low voltage lights along with the light bulbs do not have to be of a particular format or size.

Having thus described the invention, what I claimed as new and desired to be secured by Letters Patent is as follows:

1. A method to provide better vision of numbers and/or letters in dark areas or at night by producing a product that lights the fixture to read the letter(s) and/or numbers, comprising the steps of:
a. providing said a low voltage light that displays numbers and letters used to read such things as address numbers and street signs;
b. placing a low voltage light in the fixture that's designed in the shape of a number or letter;
c. either fixating the numbering or lettering on a panel or creating a numerical/lettering shape which is then brightened through many different methods.
